(19) United States
(12) Patent Application Publication
(10) Pub. No.: US 2026/0040075 A1
(43) Pub. Date: Feb. 5, 2026

(54) METHOD FOR CONFIGURING A USER DEVICE, CONFIGURATION PROGRAM, COMPUTER-READABLE DATA CARRIER, USER DEVICE AND CONFIGURATION ARRANGEMENT THEREFOR

(71) Applicant: Giesecke+Devrient mobile security Germany GmbH, Munchen (DE)

(72) Inventors: Ulrich Huber, Munich (DE); Michael Schnellinger, Munich (DE)

(73) Assignee: Giesecke+Devrient Mobile Security Germany GmbH, Munchen (DE)

(21) Appl. No.: 19/284,872

(22) Filed: Jul. 30, 2025

(30) Foreign Application Priority Data
Jul. 31, 2024 (DE) 102024121784.7

(51) Int. Cl. H04W 12/08; H04W 8/04; H04W 12/041; H04W 12/69

(52) U.S. Cl. CPC H04W 12/08; H04W 8/04; H04W 12/041; H04W 12/69

(57) ABSTRACT

Systems and methods for participation in a telecommunications network. A secure element manages at least one profile data set for secure operation of a user device. An element identifier is provided for identifying the secure element. A location identifier is provided for a home location register of a telecommunications network. At least one login credentials item is provided for logging on the user device.

### CROSS REFERENCE TO RELATED DOCUMENT(S)

This application claims priority to DE Application No. 10 2024 121 784.7 entitled “Method for configuring a user device, configuration program, computer-readable data carrier, user device and configuration arrangement therefor” and filed on Jul. 31, 2024, which application is incorporated by reference in its entirety.

### TECHNICAL FIELD

The present disclosure relates to providing data for secure elements, and more specifically to providing data for secure elements which include user profiles for authorizing an operation of user devices.

### BACKGROUND

Methods for handling embedded secure elements, such as eUICCs, as well as computer programs, computer-readable data carriers, user devices for participation in communication networks and communication networks are known from the prior art. On eUICCs, for example on mobile user devices such as cell phones, smartphones, tablets or similar, the respective identification features of users of the user devices are managed. On an eUICC, this is usually done in the form of corresponding embedded subscriber identity modules (eSIM). This procedure is necessary in order to fulfill the security requirements required to manage the identification features. This requires a trusted party that can be provided on eUICCs and/or servers, such as eSIM download servers, from which eUICC data sets can be obtained or managed as trusted Subscription Manager Data Preparation platforms (SM-DP+) while fulfilling the respective security requirements.

Secure elements usually have a system structure with an operating system so that they can interact with device components of user devices on which they are implemented. Memory areas, usually non-volatile memory, of secure elements can be accessed via the operating system and information stored in them, such as identification features, can be handled, managed and queried. For example, this is done using data elements of corresponding application protocols (Application Protocol Data Unit—APDU), which transmit commands unidirectionally via a connection interface to secure elements, which are then executed by them.

DE 10 2021 001 850 A, for example, relates to a method for personalizing a secure element with the following method steps: Receiving, in a data generator, a request for a bundle of memory images for a plurality of secure elements, wherein each requested memory image of the received bundle concerns a secure element of the plurality of secure elements and wherein a respective secure element of the plurality of secure elements is or is permanently installed in a corresponding terminal device of a plurality of terminal devices; obtaining, in the data generator, at least one subscription record for at least one secure element of the plurality of secure elements to be personalized, wherein the subscription record is obtained from a subscription management server; providing, by the data generator, an operating system or a part of the operating system for the secure element to be personalized; generating, by the data generator, a memory image for each of the secure elements according to the received request, wherein the memory image of the secure element to be personalized comprises the provided operating system or the part of the operating system and additionally the received at least one subscription data set; and bundling the generated memory images and providing the bundled memory images as a memory image bundle from the data generator to complete the terminals at inserting at least the memory image of the secure element to be personalized into the secure element to personalize the secure element.

U.S. Pat. No. 10,277,587 B2 describes methods for instantiating multiple electronic subscriber identity modules (eSIMs) on an electronic universal integrated circuit card (eUICC) using a large data binary object (data blob) installed by the manufacturer. An eSIM package including the data blob in encrypted form is securely installed in the eUICC in a manufacturing environment. A Key Encryption Key (KEK) associated with the eSIM package is provided separately to the factory of an Original Equipment Manufacturer (OEM) for wireless devices. The wireless OEM factory provides the KEK to the eUICC within a specific wireless device. The eUICC uses the KEK to decrypt the eSIM packet and provide the data blob. The eUICC may receive a request to instantiate a first eSIM. The eUICC can instantiate the first eSIM using data from the data blob. A user can then access network services via the wireless device. A second eSIM can then be instantiated by the eUICC using the data blob.

EP 2 533 485 B1 relates to methods and devices in a mobile communication system for over-the-air management of mobile stations containing a secure identification element, preferably a subscriber identity module. Based on a standard challenge-response authentication method implemented in a mobile communication system, not to be used for the intended authentication purpose, but for providing a mobile station with subscription and/or instruction data. The standard challenge-response authentication method is modified in such a way that the challenge is used as a carrier for subscription and/or instruction data. This challenge containing the subscription and/or instruction data is provided to the mobile station in response to a request from the mobile station to access or connect to the mobile communication system, and includes a special mode indicator data element indicating to the mobile communication system that the mobile station is requesting subscription and/or instruction data, and is therefore suitably forwarded to a data providing entity configured to provide subscription and/or instruction data.

Methods and systems known in the prior art for providing and updating secure elements of user devices, including operating system updates, may not fulfill all requirements in terms of deployability and availability on the one hand and functional safety and security on the other hand. For example, it is desirable that both the operating system and the secure elements have the same origin and the same level of development to ensure functional safety and security. However, due to limitations in usability and availability, it cannot always be guaranteed that the operating system and the secure elements have the same origin and corresponding versions or meet certain future requirements, especially if a new specification or standard for the operation of user devices is expected to be introduced during the lifetime of the user device and/or the respective secure element.

This may limit the functionality, in particular a range of (future) capabilities, of the user device, affect the functional safety and security in the operation of user devices or even result in the devices not being able to be configured correctly, taking into account that not only the operating system but also the associated data structures may be affected by update procedures. In order to bring the range of functions of the user devices and their devices up to date and to ensure an appropriate level of development, it is desirable to load both the operating system and the data structures onto the secure elements as shortly as possible before delivery to a user. At the same time, the data structures should enable connectivity with a network operator of a telecommunications network and thus enable connectivity as soon as possible after delivery in order to be able to retrieve further data, such as control data for the user devices, via telecommunications networks, possibly also private networks. However, the network operator may not yet be known when the user device together with the secure element is to be delivered to a user or a secure element to a manufacturer of user devices, for which the known state of the art cannot yet offer a satisfactory solution.

### SUMMARY

Systems and methods of the present disclosure can enable user devices and/or secure elements to be provided as shortly as possible before the time they are delivered to a user or manufacturer of the user devices. For example, they can provide a way of handling secure elements and their operating systems and data structures in such a way that a future-proof range of functions, security and protection can be guaranteed without impairing the usability, availability and/or data integrity, in particular communication capability, of the user devices or their secure elements.

Features described herein in relation to methods and corresponding method steps can be implemented as device features or vice versa. Sections of the description relating to the method therefore also apply analogously to computer programs, computer-readable data carriers, user devices for participation in communication networks and communication networks. In particular, method steps and components mentioned in connection therewith can be implemented as functions of the computer or configuration programs, computer-readable data carriers, user devices for participation in communication networks and communication networks, and any functions of the configuration or computer programs, computer-readable data carriers, user devices and setup arrangements for configuring the user devices for participation in communication networks and communication networks can be implemented as method steps.

Method for configuring a user device, for example a mobile user device for participation in a telecommunications network, with a secure element, in particular an eUICC, which is designed to manage at least one profile data set for secure operation of the user device, comprising the following steps: providing an element identifier for identifying the secure element; providing a location identifier for a home location register of a telecommunication network; and deriving at least one login credential for logging in the user device from the element identifier and the location identifier and/or a local operator key associated with the location identifier.

Configuration program, comprising commands which, when the configuration program is executed by a user device, cause the user device to perform a corresponding method.

Computer-readable data carrier with a corresponding configuration program stored thereon, as claimed.

User device, in particular a mobile terminal device for participating in a communication network, with a corresponding configuration program according to a computer-readable data carrier and/or configured for carrying out a corresponding method.

A configuration system for configuring user devices, with a corresponding configuration program stored therein, a corresponding computer-readable data carrier and/or for executing a corresponding method.

The method can thus be executed accordingly by a data processing device or with the aid of a computer, which can be implemented as a user device or server. A configuration or computer program may comprise instructions which, when the program is executed by a data processing device or computer, cause it to carry out the method. A computer-readable storage medium, a computer-readable data carrier and/or a data carrier signal can store or transmit the configuration or computer program. A corresponding computer-readable data carrier can be provided as a computer-readable medium and/or data carrier signal.

The element identifier can be a unique electronic identifier (eUICC identifier—eID) for identifying the secure element. The location identifier can be a location-dependent identifier, in particular a country identifier, such as a mobile country code (MCC) and/or mobile network code (MNC). The local operator key can be assigned to the location identifier.

The configuration or computer program may be provided as an application program for a user device and/or a server, for example for and/or as part of a Home Location Register (HLR). The configuration arrangement may comprise the computing or server device for configuring user devices. For example, the server device may comprise a home location register.

The solution according to an embodiment can provide that the login credentials for logging in the user device or the secure element to a telecommunications network of a respective network operator can be generated or provided for the secure element after the location identifier or the local operator key has become known. The login credentials can be generated at a manufacturer and/or purchaser of user devices after the secure element has been delivered to the manufacturer or purchaser. The customer can then deliver the user device to the user relatively soon after the credentials have been provided, who in turn immediately has connectivity to a telecommunications network with the user device or secure element, so that further data, such as control data, can be obtained via the telecommunications network.

In this way, a provisioning and/or configuration period between the assignment of the login information and the delivery or connectivity capability of the user device and/or secure element can be kept as short as possible. This also allows all other data components on the secure element or for this and/or the user device, such as operating system and/or control data sets, device firmware, etc., to be provided at a relatively late point in time and therefore with the highest possible degree of up-to-dateness. This helps to improve and simplify the usability, availability and/or data integrity, in particular communication capability of the user devices or their secure elements.

The solution is not limited to eUICCs, but is generally suitable for so-called secure elements (SEs) or tamper-resistant elements (TRE), which are referred to herein, for example, as integrated circuit cards. As such, in addition to eUICCs, secure elements include, for example, classic UICCs, integrated UICCs (iUICCs) and all integrated secure elements of other types, such as integrated secure elements (iSE/eSE), smart cards, subscriber identity modules, subscriber identity modules (SIMs) and/or virtual SIMs (vSIM). What all such secure elements have in common is that user data sets or eUICC data sets can be stored on them, for example as telecommunications profiles or “profiles” for short, with the help of which users can authenticate themselves to communication networks, for example as subscribers in telecommunications networks. The secure elements are characterized in each case by the fact that the information stored on them, i.e. in particular the profiles, is particularly protected against attacks by third parties and cannot be easily manipulated either physically or by software.

According to one embodiment, it may be provided that the at least one login credential comprises a profile identifier and/or a security key. The profile identifier may be a unique subscriber number or International Mobile Subscriber Identity (IMSI). The security key may be a unique security key and/or key for the exchange of data commands or data elements of the application protocol. Thus, the profile identifier and/or security key can be provided at a relatively late stage, which helps to improve and simplify usability, availability and/or data integrity, in particular communication capability of the user devices or their secure elements.

According to one embodiment, it may be provided that the element identifier and/or the local operator key are obtained from a secure entity. The trusted entity may be an entity with appropriate security certification. This helps to ensure the required level of security when providing the element identifier and/or the local operator key.

According to one embodiment, it may be provided that the local operator key is derived from a master key. The secure entity may derive the local operator key or a set of local operator keys from the master key or a master operator key. The keys can be managed by the secure entity in a hardware security module. For example, the local operator keys can be generated individually for a respective location identifier or network identifier. This further helps to ensure a required level of security and/or integrity in the provision of local operator keys.

According to one embodiment, it may further comprise a step of recognizing a location of the secure element for providing the location identifier and/or the local operator key. For example, the secure element can recognize its location itself when it is switched on for the first time. Alternatively, or additionally, a computing device such as a server for configuring the secure element or user device can recognize, assign or communicate the location to the secure element. This can also help to improve and simplify the usability, availability and/or data integrity, in particular the communication capability of the user devices or their secure elements.

According to one embodiment, it may be provided that an auxiliary profile data set and/or auxiliary credentials stored therein is/are used to identify the location of the secure element. The auxiliary profile data set may be a temporary user profile. The auxiliary credentials can include a temporary profile identification of an auxiliary profile data set or be provided as such so that a network logon can be performed based on it. The network logon can take place at a network intended for this purpose, such as a private network and/or a telecommunications network. The private network can be a network of a customer or manufacturer of secure elements and/or user devices. The telecommunications network can be a network of a respective network operator. These networks can have their own network identifier or location identifier. After logging into such a network, the secure element or user device can perform setup steps that require network login, such as location detection. This can again help to improve and simplify the usability, availability and/or data integrity, in particular the communication capability of the user devices or their secure elements.

### BRIEF DESCRIPTION OF THE DRAWINGS

FIG. 1 shows a schematic view of an embodiment of a configuration system according to an embodiment with at least one user device and at least one server device, which are adapted to carry out a method for configuring the at least one user device.

FIG. 2 shows a schematic view of a further embodiment of a configuration system according to an embodiment with at least one user device and at least one server device, which are adapted to carry out a method for configuring the at least one user device.

### DETAILED DESCRIPTION

The illustrations in the figure are schematic and not to scale. If the same reference symbols are used in different figures in the following description of the figures, these generally denote identical or similar elements. However, identical or similar elements may also be designated by different reference signs.

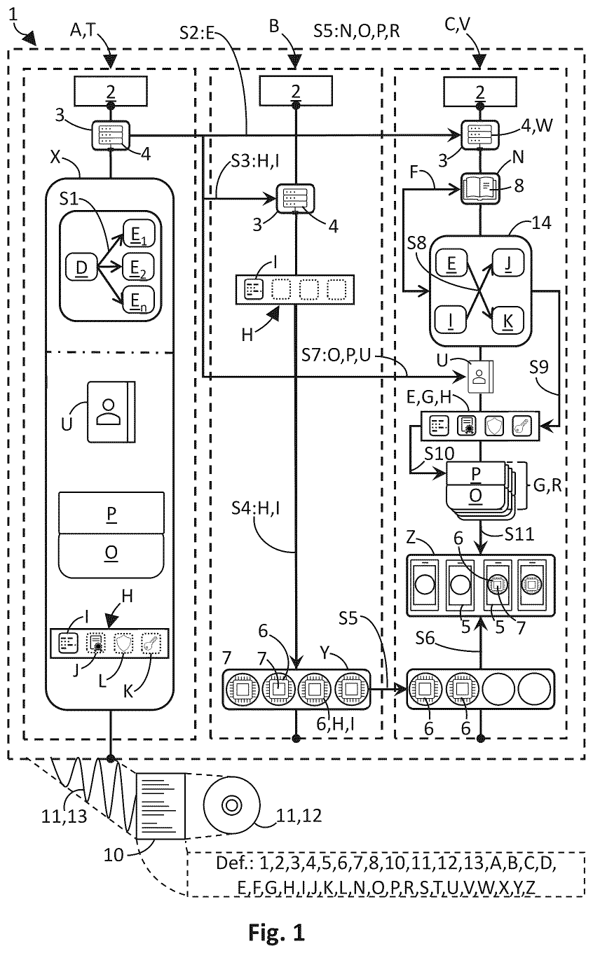

FIG. 1 shows a schematic representation of a configuration system 1 comprising at least one computing device 2, for example in the form of a server device 3 controlled by a trusted entity T, which may contain a hardware security module 4 designed to store, manage and/or provide data sets for configuring a further computing device 2. The further computing device 2 may be configured as a user device 5, which may be in the form of an Internet of Things (IoT) device, such as a multimedia device, camera, speaker, household appliance, measuring device, industrial equipment, vehicle, vending machine or the like, which is to be associated with a machine entity, and/or as a smart card, identification card, transaction card, personal mobile device, such as a smartphone, smartwatch, etc., which is to be associated with a person entity. The server device 3 can, for example, be provided in the form of a server for Subscription Manager Data Preparation+(SM-DP+).

In the present example, the configuration system 1 and the corresponding method comprise a data provision facility A, which may serve as or be operated by the trusted entity T and provide login credentials H, operating system data sets O and/or profile data sets P, a production facility B, which may produce the secure elements 6, and a manufacturing facility C, which may manufacture the user devices 5. The data facility A, the production facility B and/or the manufacturing facility C can be combined functionally and/or spatially as desired or required. Data connections can be established between the data facility A, the production facility B and/or the manufacturing facility C as communication connections F or radio connections F, respectively.

The user devices 5 may be configured for secure operation, transactions and/or communication, e.g. via a telecommunications network (not shown), by means of at least one profile data set P for a user or operator stored in a corresponding secure element 6 or tamper-resistant element (TRE), such as a UICC, eUICC, iUICC, SIM, eSIM, iSIM, SE, eSE or the like, which may be provided in the form of a computer chip. The profile data sets P are generated on the basis of corresponding personal data sets or user data sets U contained in data files on the server device 3, in particular the hardware security module 4 of the trusted entity T. To store and manage profile data sets P on the secure elements 6, an operating system data set O is installed on the secure element 6, for example in a secure storage location 7, such as an Issuer Security Domain—Root (ISD-R) provided on the secure element 6. The secure storage location 7 may have different storage areas.

In a data provision phase X, operating system data sets O and/or profile data sets for the user devices 5 based on respective personalization data or user data U can be stored in the data facility A, for example in the server device 2 of the secure entity T, in particular on its hardware security module 3. In the data provision phase X, this data can be kept up to date in order to make it available to the production facility B and/or the manufacturing facility C as required in a respective production phase Y and/or manufacturing phase Z for configuring the user devices 5 or their secure elements 6. Alternatively, or additionally, the production phase Y and/or the manufacturing phase Z can be arranged in and/or combined with the data facility A as desired or required.

A management application 8 or Home Location Register (HLR) may be provided, which may be configured to enable a network provider N, such as a Mobile Network Operator (MNO), to communicate with the user device 5, in particular the secure element 6, using the user profile P stored therein, or to establish secure communication connections F, for example directly and/or via a communication interface (not shown) to the user device 5. The user profile P may comprise the credentials H or security credentials, including element identifiers I, profile identifiers J, security keys K and/or authentication certificates L. The security credentials H may be any type of credentials H, including element identifiers I, profile identifiers J, security keys K and/or authentication certificates L. The security credentials H may comprise any type of credentials defined by, for example, the GSMA or the like. The security keys K may comprise all types of cryptographic codes or key elements that may be suitable for interaction with the user devices 5, the secure elements 6, the server device 3 of the trusted entity T as issuer of a part of the operating system data set O, the management application 8 of the network operator N and/or a component thereof.

The authentication certificates L may be, for example, any type of electronic certificate that may be issued by the trusted entity T to authenticate the origin of the user devices 5, the secure elements 6, the secure storage location 7, management application 8 and/or the operating system data set O. Transmission lines (not shown) may be provided for handling and/or transmitting the operating system data set O, which may include any type of wired and/or wireless transmission chains as communication links F and radio connections, respectively, including the Internet (for “over-the-air” transmissions) and other physical and/or non-physical data carriers that may be configured and secured as desired and required by the configuration system 1 and its components. Furthermore, the operating system data set O may include executable data sub-sets that may define application processes and/or be configured to access data objects. Installation and/or update processes can generally be executed using an installation data set, for example a secure installation program, which can be issued by the secure entity T. The installation data set may be provided as part of the operating system data set O.

In each of the embodiments of the configuration system 1 described here, the computing devices 2 and the secure element 6 in particular can be adapted and configured so that they can execute a computer program in the form of a configuration program 10. The configuration program 10 can be stored on a computer-readable data carrier 11, which can be configured as a computer-readable medium 12 and/or as a data carrier signal 13. When the configuration program 10 is executed, the security system 1 and its components communicate as specified in the configuration program 10. Parameters associated with and/or underlying the security system 1, its components and/or the steps S performed by it may be defined in and/or by the configuration program 10.

In a first step S1, at least one local operator key E can be derived by the data provision facility A in the data provision phase X from a master key D, such as a master operator key (master OP), which can be assigned to a location V of the management arrangement 8. The location V may have a corresponding location identifier W, such as a mobile country code (MCC) and/or mobile network code (MNC). A plurality or series of local operator keys E1 to En may be provided, each of which may be assignable to a corresponding location V with a corresponding location identifier W.

In a second step S2, the local operator key E may be provided to the manufacturing facility C located at the location V for which the local operator key W is provided. Irrespective of this, possibly on the basis of user data U already available at this point in time, in a third step S3 the login credentials H can be provided by the data provision facility A in the data provision phase X at least to such an extent that an element identifier I is available for secure elements 6 to be produced. This third step S3 can be performed before, after and/or in parallel with the first step S1. In the present example, the rudimentary credentials H, for example the element identifier I, are made available to the production facility B, wherein a corresponding data transmission can be carried out using the server devices 3 or hardware security modules 4 of the data provision facility A and/or the production facility B.

In a fourth step S4, the secure elements 6 can be provided with the rudimentary credentials H, such as the element identifier I, by the production facility B in the production phase Y. In a fifth step S5, the secure elements 6 provided with the rudimentary login credentials H can be made available to the manufacturing facility C. In a sixth step S6, the user devices 5 can be provided with the secure elements 6 in the manufacturing facility C in the manufacturing phase Z.

In a seventh step S7, the user data U, operating system data sets O and/or profile data sets P can be provided to the manufacturing facility C, wherein a corresponding data transmission can be carried out using the server devices 3 or hardware security modules 4 of the data provision facility A and/or the manufacturing facility C. In an eighth step S8, a profile identifier J and/or a security key K for a user profile P and/or operating system data set O can be derived from the local operator key E and a respective element identifier I of the secure elements 6 provided to the manufacturing phase Z or installed in a user device 5. A communication connection F to the management application 8 can be established for this purpose.

The derivation step can be carried out using an application program 14, which can be provided by the secure entity T of the manufacturing facility C, for example as part of the second step S2. With the derivation of a profile identifier J and/or a security key K for a user profile P and/or operating system data set O, remaining credentials H can be produced or provided so that a complete registration data set G, for example OPc according to the GSM standard, can be made available as part of the now complete credentials H of the respective profile data set P and/or operating data set O, which can be used for logging in to the management application 8 by the user device 5. The authentication algorithm R can, for example, be a Milenage/TUAK algo code, which can be stored in the memory area 7 and executed from there.

In a ninth step S9, the set of complete credentials H or a corresponding registration data set G can be provided. In a tenth step S10, a respective operating system data set O and/or profile data set P can be compiled or provided on the basis of the login credentials H or the registration data set G. In an eleventh step S11, operating system data set O and/or profile data set P and/or login credentials H and/or registration data set G can be loaded onto the respective secure element 6 provided for this purpose. The corresponding data can be installed in the secure storage location 7 of the secure element 6. The user device 5 with the secure element 6 is now ready for use. This means that all the login credentials H required to use a telecommunications network is available on it as registration data set G, which may in particular include local operator key E, element identifier I, profile identifier J, security key K and/or certificate L.

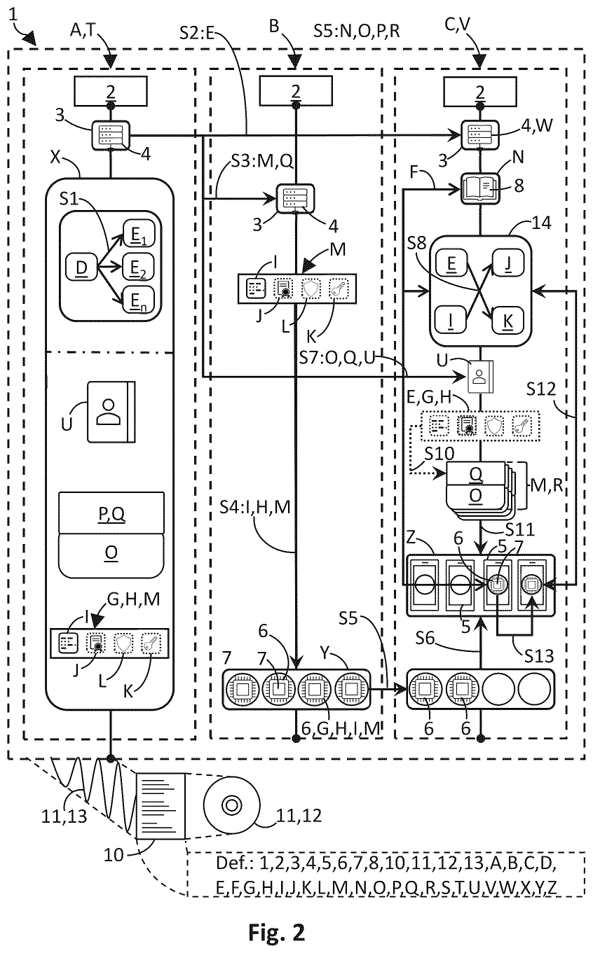

FIG. 2 shows a schematic view of an embodiment example of a configuration system 1 according to an embodiment with at least one user device 5 and at least one server device 3, which are designed to carry out a method for configuring the at least one user device 5. For the sake of efficiency and brevity, only the differences between the embodiment example described in FIG. 1 and the embodiment example described in FIG. 2 will be discussed below. Thus, according to the embodiment example shown in FIG. 2, auxiliary profile data sets Q and/or auxiliary credentials M are provided by the secure entity T.

The auxiliary profile data sets Q can already contain all the login credentials H or the respective registration data set G in the form of corresponding auxiliary login information M required for logging on to a network operator N. The auxiliary profile data sets Q can simulate profile data sets P. Accordingly, they can be based at least in part on fictitious or makeshift user data U. As such, the auxiliary registration information can already be made available to the production facility B in the third step S3. This can load the auxiliary registration information M onto the secure elements 6 in the fourth step S4 as part of the creation phase Y and make this information, together with the auxiliary registration information M, available to the manufacturing facility C in the fifth step S5.

In the manufacturing facility C, the tenth step S10 can now be virtually dispensed with by either prefabricating auxiliary profile data sets Q in the eleventh step S11 for the manufacturing phase Z and loading them onto the secure elements 6 or by already loading them onto the secure elements 6, for example, by installing them on the secure elements 6 by the production facility B in the production phase Y. In a twelfth step S12, the secure elements S12 can query their location V and/or a corresponding location identifier W via a communication link F and generate an actual local operator key E from this themselves and/or in cooperation with the application program 14.

In a thirteenth step S13, the user devices 5 or their secure elements 6 can then replace the previously existing auxiliary registration information M with an actual registration data set G provided in accordance with user data U with corresponding complete or final login credentials H. This means that the location can be identified by registering with the network operator N. While this network operator N can be a public network operator, a private network operator can be used alternatively or additionally, particularly in the embodiment example shown in FIG. 1.

During the process described above, the secure storage location 7 or its storage areas can be used to store data sets or data objects in accordance with the respective requirements. In particular, the login credentials H, the operating system data set O, the profile data set P and/or associated authentication algorithms R can be stored in the secure storage location 7 in such a way that they cannot be changed and/or lost, for example by designing the secure storage location at least partially as read-only memory (read-only memory—ROM). The respective server device 3 can provide any data components of the configuration system 1, including the operating system data set O, possibly together with an installation program data set, the respective diversified data, such as the security credentials H and/or the user profile P associated with the user U, to the management application 8 and/or the secure element 6 of the user device 5, for example via the communication interface 9, in order to store them for use by the network operator N or at the secure storage location 7 for use by the user U, respectively

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Details of the exemplary embodiments or other limitations described above should not be read into the claims absent a clear intention to the contrary. Any implementation described herein as exemplary is not necessarily to be construed as preferred or advantageous over other implementations, and the exemplary embodiments described herein are not intended to limit the scope or applicability of the subject matter in any way. Accordingly, it should be appreciated that the exemplary embodiment or embodiments described herein are not intended to limit the scope, applicability, or configuration of the claimed subject matter in any way. Rather, the foregoing detailed description will provide those with ordinary skill in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

It is claimed:

1. A method for configuring a user device for participation in a telecommunications network, with a secure element being an eUICC, which is adapted to manage at least one profile data set for secure operation of the user device, said method comprising:
providing an element identifier for identifying the secure element;
providing a location identifier for a home location register of a telecommunications network; and
deriving at least one login credential for logging in the user device from the element identifier and the location identifier and a local operator key assigned to the location identifier.

2. The method of claim 1, wherein at least one login information comprises a profile identifier and a security key.

3. The method of claim 2, wherein the element identifier and the local operator key are obtained from a secure entity.

4. The method of claim 3, wherein the local operator key is derived from a master key.

5. The method of claim 4 further comprising:
detecting a location of the secure element for providing the location identifier and the local operator key.

6. The method of claim 5, wherein for identifying the location of the secure element, an auxiliary profile data set and auxiliary credentials stored in the secure element are being used.

7. The method of claim 1, wherein a configuration program includes instructions which, when the configuration program is executed by a computing device, cause the computing device to carry out the method.

8. The method of claim 7, wherein a computer-readable data carrier includes a configuration program stored thereon according to claim 7.

9. The method of claim 8, wherein a user device, for participation in a communication network, has stored thereon the configuration program, the computer-readable data carrier, and the user device is configured to carry out the method.

10. The method of claim 9, wherein a configuration system is provided for configuring user devices.
